(19) United States
(12) Patent Application Publication
(10) Pub. No.: US 2003/0085558 A1
(43) Pub. Date: May 8, 2003

(54) Micro airbag safety system

(76) Inventors: Jonas Forssell, Gothenburg (SE); Martin Weiman, Gothenburg (SE); Martin Wedel, Northville, MI (US); Jan Ivarsson, Billdal (SE)

Correspondence Address: FORD GLOBAL TECHNOLOGIES, INC, SUITE 600 - PARKLANE TOWERS EAST, ONE PARKLANE BLVD., DEARBORN, MI, 48126, US

(21) Appl. No.: 09/682,952

(22) Filed: Nov. 2, 2001

(30) Foreign Application Priority Data
Nov. 4, 2000 (EP) 00123776.7

(51) Int. Cl. B60R 21/26

(52) U.S. Cl. 280/741

(57) ABSTRACT

The present invention relates to a safety system and method for protecting objects in a vehicle from possible damage due to sudden impact thereon. The safety system comprises a plurality of protective elements (1) arranged to be expandable and releasable from an original position in order to fill up a volume and provide damping for the objects.

### BACKGROUND OF INVENTION

The present invention relates to a safety system for protecting objects in a vehicle from possible damage due to sudden impact thereon. The invention also relates to a method for protecting objects in a vehicle.

Inflatable cushion systems commonly referred to as air bag systems have been used in the past to protect both the operator of the vehicle and passengers. Systems for the protection of the vehicle operator have typically been mounted in the steering column of the vehicle and have utilised cushion constructions directly deployable towards the driver.

It is a well-known issue of modern conventional airbag technology for especially vehicles that these prior art airbag systems only provide optimal protection for a properly positioned operator in specific impact situations. There is a need to improve current airbag technology in order to cover also other situations.

Inflatable cushions for use in the protection of passengers against frontal or side impacts must generally have a more complex configuration since the position of a vehicle passenger may not be well defined and greater distance may exist between the passenger and the surface of the vehicle against which that passenger might be thrown in the event of a collision.

Current direction on improving these systems is adding more bags and advanced control systems. The more advanced the system gets the more important it is to adapt the system to the actual operator of the vehicle and the passengers. It is not only the position of the objects in the vehicle but also their size and shape that needs to be taken into account. Very sophisticated sensors are typically placed in advanced vehicle compartments in order to provide all this information to the air bag system. This information is used in combination with information from the impact sensors of the vehicle to provide best possible protection of the objects in case of impact on the vehicle.

Impact situations are generally very complex and a multitude of different parameters, in addition to the above outlined, actually need to be determined in order for the conventional air bag systems to provide accurate protection in a specific case. In order to improve this technique the conventional air bag systems become very complex.

However, a second issue with a conventional air bag system is that the bag when triggered almost instantly is provided with a high energy content. This energy provides a force that may cause serious damage on an object in the vehicle especially if the force is concentrated on a small area of the object. This is especially a problem if the objects in the vehicle such as children or older people are especially sensitive to sudden impact.

The overall problem for conventional air bag technology is thus to provide protection in a system of reasonable complexity for passengers in different impact situations independent of, for example, the passengers” shape, size, weight, position and physical condition.

### SUMMARY OF THE INVENTION

The object of the present invention is to provide a safety system that overcomes the above issues, and makes it possible to provide a system for cushioning a movable object within a compartment against injury from sudden impact without directing too much of the impact energy on a specific location of the movable object.

In accordance with the objects of this invention, a micro airbag safety system is provided. The present invention relates to a safety system and method for protecting objects in a vehicle from possible damage due to sudden impact thereon. The safety system comprises a plurality of protective elements arranged to be expandable and releasable from an original position in order to fill up a volume and provide damping for the objects.

Additional advantages and features of the present invention will become apparent from the description that follows, and may be realized by means of the instrumentalities and combinations particularly pointed out in the appended claims, taken in conjunction with the accompanying drawings.

### BRIEF DESCRIPTION OF DRAWINGS

In order that the invention may be well understood, there will now be described some embodiments thereof, given by way of example, reference being made to the accompanying drawings, in which:

FIG. 1 is a part of the inflatable elements mounted together on a panel or the like according to a preferred embodiment of the invention;

FIG. 2 is a cross section of an inflatable element according to the present invention;

FIG. 3a is a schematic view of a personal car equipped with a safety system according to the invention and shows the initial trigging of a protective element in a vehicle;

FIG. 3b is a schematic view of a personal car equipped with a safety system according to the invention and shows inflatable elements expanding and discharging into the compartment actuated by a sudden impact; and

FIG. 3c is a schematic view of a personal car filled with protective elements according to the invention.

### DETAILED DESCRIPTION

In the following figures, the same reference numerals will be used to identify identical components in the various views. The present invention is illustrated with respect to a micro airbag system, particularly suited for the automotive field. However, the present invention is applicable to various other uses that may require a micro airbag safety system.

The effects of injury from sudden impact on occupants in a vehicle in case of an automobile accident would be less if a plurality of protective elements were discharged around an object in the vehicle in order to dampen the sudden impact. A sudden accelerating or decelerating force applied to an object over a large surface area thereon will tend to have a less severe effect and will tend to cause less damage than if the same force is concentrated on a small area of the object. The total energy content from a conventional air bag type is divided into a plurality of protective elements.

This arrangement is also effective regardless of the shape, size, weight or location of the object due to the flexibility of the plurality of protective elements according to the invention.

In a preferred embodiment of the invention the protective elements are arranged to expand by means of inflation. This makes the positioning of a group of non-activated protective elements on a panel or similar in the vehicle easy since it does not require a lot of space. As long as they are not being triggered the protective elements are about the size of a pea which makes such a group easy to place in the vehicle. This arrangement also provides a rapid expansion and discharge of the system, which is crucial in case of a sudden impact.

In a preferred embodiment of the invention the protective elements are arranged to fill a volume in a compartment of said vehicle. The flexibility of the invention makes it possible to provide different sections of the vehicle with protective elements in order to obtain an efficient course of the filling of the actual vehicle compartment. It is also possible to provide other sections, such as the engine housing of the vehicle with protective elements to achieve better protection and less damage on objects of the vehicle. Consequently, it is possible to provide e.g. a door structure or a luggage compartment with the protective elements according to the invention.

According to the invention at least one of said protective elements comprises a trigger connected to at least one impact sensor. Another advantage with the pre-sent invention is that a conventional impact sensor sys-tem may be used in order to transmit the necessary information and possibly activate the protective elements. In an embodiment of the invention the trigger is electronically connected to at least one impact sensor.

As mentioned the protective elements are arranged on a panel element in their original position. As an alter-native the protective elements are directly connected to one another in their original position. The protective elements may then be placed at selected areas in the compartment.

The flexibility of the system according to the invention provides the possibility of the protective elements to be arranged in combination with other safety systems for protecting objects in said vehicle from dam-age due to sudden impact.

In a preferred embodiment of the invention said protective elements are each substantially spherical when expanded. This spherical shape of the elements allows a high coefficient of fullness of the volume in the compartment.

Preferably, each said protective element has at least a permeable expandable cover, said cover being preferably permeable to inflating media in order to absorb impact energy after being inflated. By making the cover permeable to inflating media, especially in case of impact, the risk for injuries or damage of the objects is decreased. This is because the elasticity of the expanded protective elements is minimized due to deflation during impact from the object. The plurality of released free-moving protective elements also provide damping due to the fact that the elements are movable in relation to one another and could hence be easily rearranged once re-leased.

Serious injuries caused by the objects bouncing back from the protective element can thus be avoided.

The protective element has a core comprising a gas-generating device. The gas-generating device will generate inflating media to the protective elements in accordance with prior art in conventional airbag technology.

The protective element thus has an expandable cover, said cover being made of a rubber like material or a polymer. A silicone-based rubber like material is considered specifically appropriate, due to the fact that the expansion of the protective element takes place under heat generation and this material is both heat resistant and expandable.

It is a further object for the present invention to provide a method for protecting objects in a vehicle from possible damage due to sudden impact thereon, by releasing a plurality of protective elements, expanding said protective elements by trigging at least one protective element with a signal from an impact sensor in order to fill a volume of the compartment in said vehicle.

Preferably, said trigging signal initiates a chain reaction comprising the steps of one protective element expanding by being triggered, the pressure from the first expanding element causing its neighboring protective elements to expand. Preferably a pressure sensitive powder is provided between the canister and the expandable cover. The pressure from an expanding element is triggering this pressure sensitive powder in neighboring elements causing an explosion, said explosion initiating an inflation of the neighboring elements. During the expansion of the element an increased pressure on the surrounding elements occurs and this increased pressure al-lows the element to be released from the original position.

Another preferred method of performing the filling of the compartment is that by trigging each said protective element by a separate trigger.

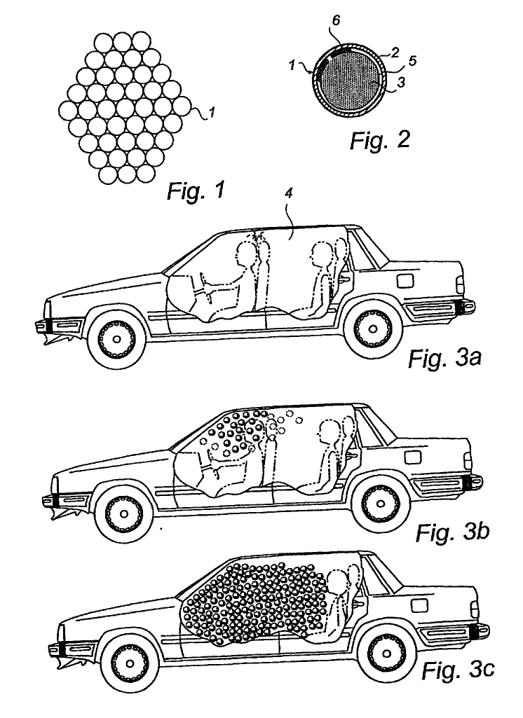

Referring to FIG. 1 of the accompanying drawings, a group comprising a plurality of protective elements 1 is arranged on a panel or similar. In this condition each protective element 1 is about the size of a pea. In a preferred embodiment of the invention at least one protective element 1 in said group is provided with a triggering mechanism.

FIG. 2 illustrates an embodiment of a pea sized spherical protective element 1 with a cover 2 and a core 3. The cover 2 consists of a rubber like material or a polymer, which has the ability to expand about 10 times relative to its original size. The cover material should also include some permeability so that deflation of con-tent media from the protective element is made possible at least in case of a sudden impact. The core 3 comprises a pressure sensitive gas generative material in a solid state, which will explode when a trigger pressure is reached. When this trigger pressure is reached, a friendly gas (like nitrogen) will be generated and expand the cover 2 into an approximate size of an orange or greater. An example of a gas generative material is potassium iodide.

The core 3 may comprise a micro inflator canister 5, said canister being surrounded by an expandable cover 2. Said canister 5 has at least one opening through which the inflating media, when the element is activated, may be let out of the canister 5 causing a surrounding cover 2 to expand.

The protective element 1 thus has an expandable cover 2, said cover 2 being made of a rubber like material or a polymer. A silicone-based rubber like material is considered specifically appropriate, due to the fact that the expansion of the protective element 1 takes place under heat generation and this material is both heat-resistant and expandable.

It is a further object for the present invention to provide a method for protecting objects in a vehicle from possible damage due to sudden impact thereon, by releasing a plurality of protective elements 1, expanding said protective elements by trigging at least one protective element with a signal from an impact sensor in order to fill a volume of the compartment in said vehicle. The trigging signal or impulse is preferably given as an electric impulse to the safety system.

Preferably, said trigging signal initiates a chain reaction comprising the steps of one protective element 1 expanding by being triggered, the pressure from the first expanding element 1 causing its neighboring protective elements 1 to expand. During this chain reaction the protective elements 1 are also being released from their original position since the strength of the attachment to the original position is lower than the initiated pres-sure. Preferably a first pressure sensitive powder 6 is provided gas generative device and the expandable cover. The pressure from a neighboring expanding element 1 is triggering this pressure sensitive powder 6 causing an explosion, said explosion triggering the gas generative device in the core 3 initiating an explosion and starting the inflation of the element 1. During the expansion of the element 1 the element 1 is being released from its original position.

Another preferred method of performing the filling of the compartment is that by trigging each said protective element 1 by a separate trigger. The expanding protective elements rapidly start filling a volume in the vehicle. Preferably the whole process of filling such a volume is performed within a period of thousandths of seconds from the initiating impact.

In an alternative embodiment of the invention separate triggers may trigger each protective element independently of other elements. This will provide a massive discharge of protective elements in the compartment.

Referring now to FIGS. 3a-c illustrating a vehicle provided with the above outlined safety system and wherein the reaction is illustrated with a series of events. In FIG. 3a the protective elements are being activated by a signal or similar from an impact sensor of conventional type. This signal starts a trigger in connection with at least one protective element 1 within a group consisting of protective elements mounted on a panel or similar.

In FIG. 3b the protective elements are being re-leased and are rapidly filling up a volume in the compartment of the vehicle. In FIG. 3c the vehicle filled with expanded protective elements.

The location of a group of protective elements 1 mounted on a panel in the vehicle can be chosen as de-sired depending on the type of vehicle. Preferably the protective elements can be located behind the dash or under the roof to give a few examples. Different groups can be placed on different areas in the vehicle compartment allowing the whole compartment to be covered if desired.

The flexibility of the protective system makes it possible to combine the protective elements with other conventional safety systems as desired.

It is a further advantage of the present invention that conventional impact sensors can be used to provide the necessary information to the safety system in case of sudden impact. The inventive idea is not dependent on any specific impact detecting system and it is a great advantage that it easily can be adapted to almost any kind of sensor system provided the sensor system has the ability to initiate a trigging mechanism of the present invention.

By sudden impact it is here and in the following understood more or less extreme situations were there is a risk for injury or damage depending on an accident or retardation.

The present invention should not be considered as being limited to the above-described preferred embodiment, but rather includes all possible variations covered by the scope defined by the appended claims.

It is thus to be appreciated that the above de-scribed material considered suitable for the protective elements need not be chosen from the previous described materials as they are given only as a way of example.

The exact shape and size of the protective elements can also be modified in order to meet specific requirements and are in the above only given as guidance.

It is also to be appreciated that the above-described features may be combined in other ways than here described to fulfill specific requirements within the field of the invention.

From the foregoing, it can be seen that there has been brought to the art a new and improved micro airbag safety system and method. It is to be understood that the preceding description of the preferred embodiment is merely illustrative of some of the many specific embodiments that represent applications of the principles of the present invention. Clearly, numerous and other arrangements would be evident to those skilled in the art without departing from the scope of the invention as defined by the following claims:

1. A safety system for protecting objects in a vehicle from possible damage due to sudden impact thereon, comprising:
a plurality of protective elements arranged to be expandable and releasable from an origin al position.

2. The safety system according to claim 1, wherein said protective elements are arranged to expand by inflation.

3. The safety system according to claim 1, wherein said protective elements are arranged to fill a volume in a compartment of said vehicle.

4. The safety system according to claim 1, wherein at least one of said protective elements comprises a trigger connected to at least one impact sensor.

5. The safety system according to claim 4, wherein said trigger is electronically connected to at least one impact sensor.

6. The safety system according to claim 1, wherein said protective elements are arranged on a panel element in their original position.

7. The safety system according to claim 1, wherein said protective elements are directly connected to one another in their original position.

8. The safety system according to claim 1, wherein said safety system is arranged in combination with other safety systems for protecting objects in said vehicle from damage due to sudden impact.

9. The safety system according to claim 1, wherein said protective element is substantially spherical when expanded.

10. The safety system according to claim 1, wherein said protective element has an expandable cover of a silicone based rubber like material.

11. The safety system according to claim 1, wherein said protective element has an expandable cover of polymer (TPE).

12. The safety system according to claim 1, wherein said protective element has at least an expandable cover, said cover being permeable to inflating media in order to absorb impact energy after being inflated.

13. The safety system according to claim 1, wherein said protective element has a core comprising a gas-releasing device.

14. A method for protecting objects in a vehicle from possible damage due to sudden impact thereon, said method comprising the steps of:
releasing a plurality of protective elements;
expanding said protective elements; and
triggering at least one protective element with a signal from an impact sensor in order to fill a volume of the compartment in the vehicle.

15. The method according to claim 14, wherein said trigging signal initiating a chain reaction comprising the steps of one protective element expanding by being triggered, causing its neighboring protective elements to expand..

16. The method according to claim 14, wherein the triggering of each said protective elements is initiated by a separate trigger.

17. The method according to claim 14, wherein the step of expanding said protective elements is caused by inflating said protective elements.

18. The method according to claim 14, wherein said protective element has an expandable cover, said cover being permeable allowing expanding media to leave in order to cause deflation after absorbing impact energy.
